(19) United States
(12) Patent Application Publication
(10) Pub. No.: US 2026/0302324 A1
(43) Pub. Date: Oct. 1, 2026

(54) LITHIUM-ION SECONDARY BATTERY AND POWER CONSUMING DEVICE

(71) Applicant: ZHUHAI COSMX BATTERY CO., LTD., Zhuhai (CN)

(72) Inventors: Hanqing Xiang, Zhuhai (CN); Yaming Qiu, Zhuhai (CN); Zhili Yu, Zhuhai (CN)

(21) Appl. No.: 19/452,418

(22) Filed: Jan. 19, 2026

(30) Foreign Application Priority Data
Mar. 25, 2025 (CN) 202510357246.2

(51) Int. Cl. H01M 10/0525; H01M 4/02; H01M 4/131; H01M 4/525; H01M 10/0567; H01M 10/0568

(52) U.S. Cl. CPC H01M 10/0525; H01M 4/131; H01M 4/525; H01M 10/0567; H01M 10/0568; H01M 2004/028; H01M 2220/10

(57) ABSTRACT

A lithium-ion secondary battery comprises a positive electrode, a negative electrode, and an electrolyte. The positive electrode comprises a positive electrode current collector and an active layer coated on at least one surface of the positive electrode current collector, and the active layer comprises a positive electrode active material, the positive electrode active material comprising a lithium cobalt oxide material and a lithium nickel cobalt manganese oxide ternary material, with the mass content percentage of the lithium nickel cobalt manganese oxide ternary material being d % based on the total mass of the positive electrode active material, where 1≤d≤50. The electrolyte comprises a compound A, a compound B, and a compound C, wherein the compound B comprises a polyether nitrile compound, the compound C comprises 1,3,6-hexanetricarbonitrile, and the compound A comprises sulfonyl-containing organic compounds.

### CROSS-REFERENCE TO RELATED APPLICATIONS

The present application claims priority to Chinese Patent Application No. 202510357246.2, titled “LITHIUM-ION SECONDARY BATTERY AND POWER CONSUMING DEVICE,” filed on Mar. 25, 2025, the entire contents of which are incorporated herein by reference.

### TECHNICAL FIELD

The present application belongs to the technical field of secondary batteries, and in particular relates to a lithium-ion secondary battery and a power consuming device.

### BACKGROUND ART

With the rapid development of technology and the continuous improvement of living standards, the demand of consumers for batteries with a higher energy density and a faster charging speed is constantly increasing. A lithium cobalt oxide material is currently a common positive electrode material for a high-energy-density lithium-ion battery. However, although the lithium cobalt oxide positive electrode material has a high capacity and a long cycling life, cobalt resources are scarce and they are expensive. The ternary material is a positive electrode material prepared from a nickel salt, a cobalt salt and a manganese salt as raw materials. As a positive electrode material with low cost, high safety and superior comprehensive performance, ternary material is gradually becoming popular.

The use of lithium cobalt oxide materials and ternary materials in combination can reduce costs while ensuring an energy density. However, the difference in voltage plateaus between the two materials leads to significant potential differences during charging and discharging, potentially causing electrochemical mismatch between different materials. During the cycling of the battery, transition metal elements in the positive electrode material will dissolve out. These metal ions migrate through the electrolyte and are reduced on the surface of the negative electrode, damaging the SEI film and causing side reactions, which deteriorate the cycling performance and safety performance of the battery.

### SUMMARY

Therefore, the technical problem to be solved by the present application is to provide a lithium-ion secondary battery and a power consuming device, so as to overcome the defects in the prior art where the use of a lithium cobalt oxide material and a ternary material in combination leads to the deterioration of the cycling performance and safety performance of the battery.

To this end, the present application provides the following technical solution.

According to an aspect of the present application, provided is a lithium-ion secondary battery, comprising a positive electrode, a negative electrode, and an electrolyte, wherein the positive electrode comprises a positive electrode current collector and an active layer coated on at least one surface of the positive electrode current collector, and the active layer comprises a positive electrode active material, the positive electrode active material comprising a lithium cobalt oxide material and a lithium nickel cobalt manganese oxide ternary material, with the mass content percentage of the lithium nickel cobalt manganese oxide ternary material being d % based on the total mass of the positive electrode active material, where 1≤d≤50; and wherein the electrolyte comprises a compound A, a compound B, and a compound C, wherein the compound B comprises a polyether nitrile compound, the compound C comprises 1,3,6-hexanetricarbonitrile; the compound A has a structure as represented by the following general formula:

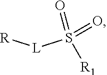

wherein L is O or a linking bond; R is selected from one of C₂-C₆ alkyl which is unsubstituted or substituted with Ra, C₂-C₆ alkenyl which is unsubstituted or substituted with Ra, C₂-C₆ alkynyl which is unsubstituted or substituted with Ra, C₂-C₆ nitrogen-containing heteroaryl which is unsubstituted or substituted with Ra, C₆-C₁₂ aryl which is unsubstituted or substituted with Ra, wherein each substituent Ra is independently selected from fluoro or C₁-C₆ fluoroalkyl; and R₁ is selected from one of fluoro or C₁-C₆ fluoroalkyl;
based on the total mass of the electrolyte, the mass content percentage of the compound A is a %, where 0.1≤a≤15; the mass content percentage of the compound B is b %, where 0.1≤b≤5; and the mass content percentage of the compound C is 0.1≤c≤5; and 0.3≤d/(b+c)≤20 and 0.02≤a/(b+c)≤2 are satisfied.

In some optional embodiments, the compound A has any of the structures as represented by the following formulae:

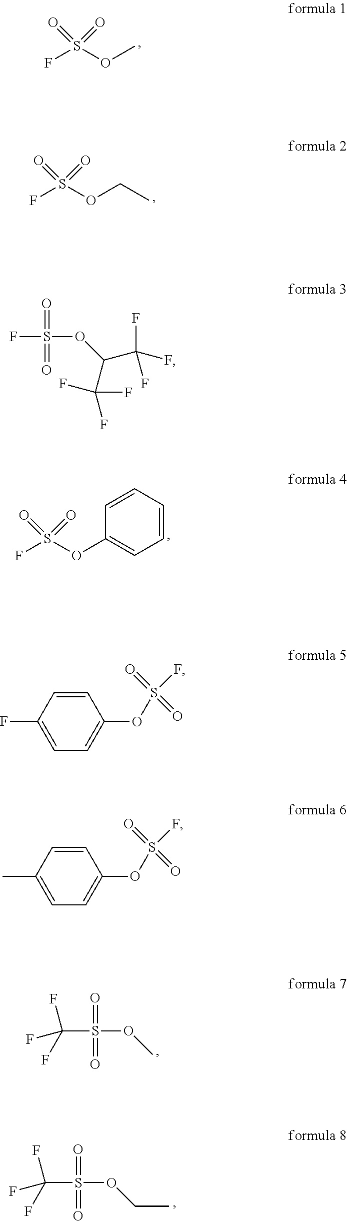

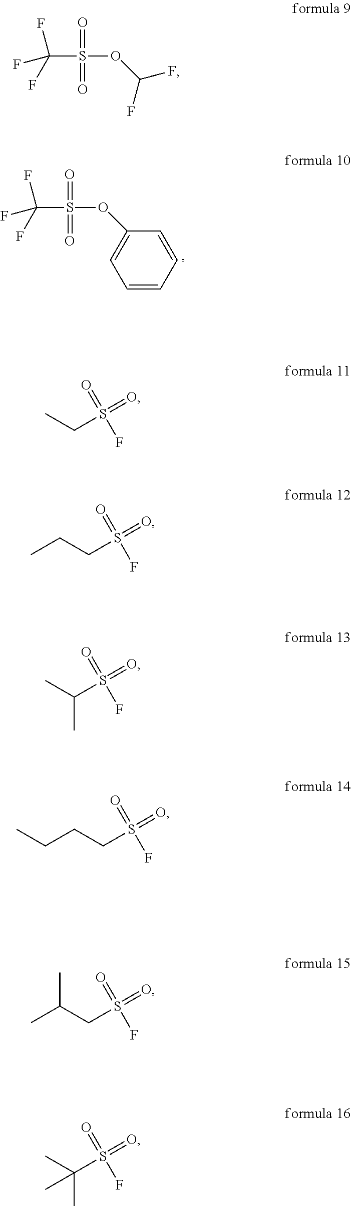

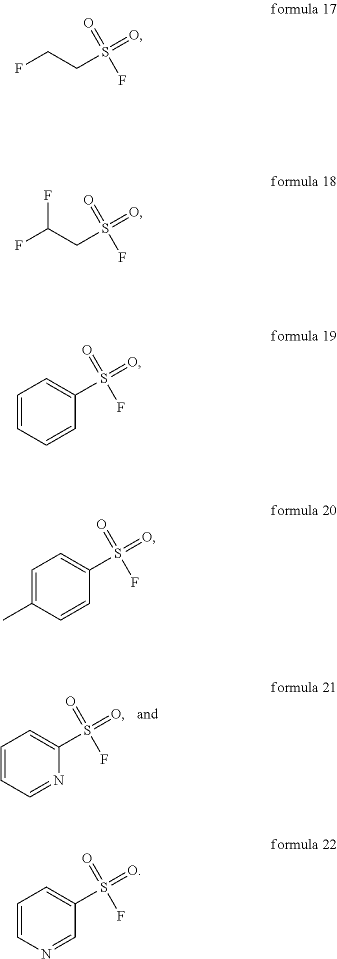

In some optional embodiments, the compound B comprises at least one of 1,2,3,4,5-penta(2-cyanoethoxy)pentane (CAS: 55726-81-3), ethylene glycol di(2-cyanoethyl) ether (CAS: 59086-77-0), diethylene glycol di(2-cyanoethyl) ether

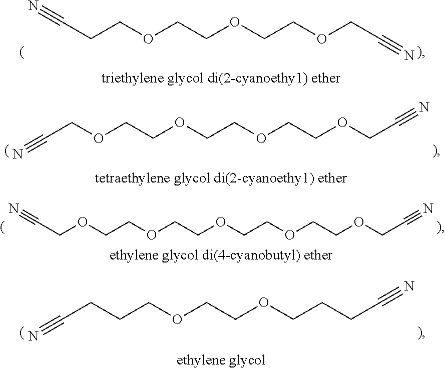 [SMILES: N#CCCOCCOCCOCC#N ; N#CCOCCOCCOCCOCC#N ; N#CCOCCOCCOCCOCCOCC#N ; N#CCCCOCCOCCCC#N]

bis(propionitrile) ether (DENE, CAS: 3386-87-6), and 1,2,3-tris(2-cyanoxy)propane (TCEP, CAS: 2465-93-2).

In some optional embodiments, the compound C further comprises at least one of benzonitrile, p-tolunitrile, 3,5-difluorobenzonitrile, adiponitrile (AND), succinonitrile (SN), 1,2,6-hexanetricarbonitrile, 3,5-bis(trifluoromethyl)benzonitrile, ethoxypentafluorocyclotriphosphazene, and hexafluorocyclotriphosphazene.

In some optional embodiments, the electrolyte further comprises a lithium salt, in a mass content percentage of 10-30%, based on the total mass of the electrolyte;

and optionally, the lithium salt comprises lithium hexafluorophosphate and lithium bis(trifluoromethanesulfonyl)imide, with the mass content percentage of lithium hexafluorophosphate being e %, and the mass content percentage of lithium bis(trifluoromethanesulfonyl)imide being f %, based on the total mass of the electrolyte, and 8≤e≤20, 0.5≤f≤10, and 1≤e/f≤5 are satisfied.

In some optional embodiments, the electrolyte further comprises ethylene carbonate, in a mass content percentage of g % based on the total mass of the electrolyte, and 0.1<g≤20 and 0.1<a/g≤0.8 are satisfied.

In some optional embodiments, the electrolyte also comprises a sulfur-containing additive, in a mass content percentage of h % based on the total mass of the electrolyte, and 0.1<h<6 and 0.3≤h/a≤3 are satisfied;
and optionally, the sulfur-containing additive has any of the structures as represented by the following formulae:

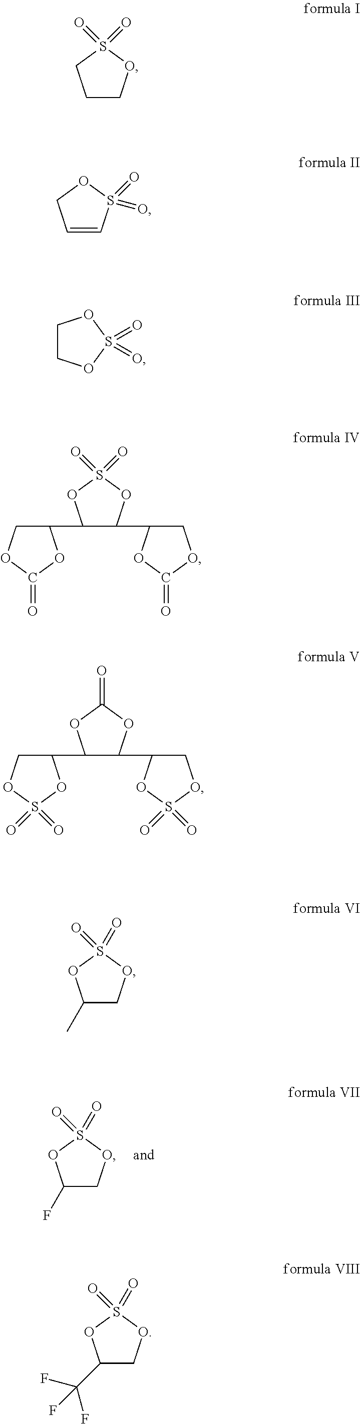

In some optional embodiments, the positive electrode active material further comprises an aluminum element, in a mass content percentage of i % based on the total mass of the positive electrode active material, where 0.3≤i≤1.2.

In some optional embodiments, the negative electrode comprises a negative electrode active material, which comprises graphite and a silicon-carbon composite material, with the mass content percentage of the silicon element in the silicon-carbon composite material being j %, where 0.5≤j≤35.
and optionally, 0.1≤j/a≤10 is satisfied.

According to a yet another aspect of the present application, provided is a power consuming device comprising the lithium-ion secondary battery as described above.

The technical solution of the present application has the following advantages.

A lithium-ion secondary battery provided by the present application comprises a positive electrode, a negative electrode and an electrolyte, wherein the positive electrode comprises a positive electrode current collector and an active layer coated on at least one surface of the positive electrode current collector, and the active layer comprises a positive electrode active material, the positive electrode active material comprising a lithium cobalt oxide material and a lithium nickel cobalt manganese oxide ternary material, with the mass content percentage of the lithium nickel cobalt manganese oxide ternary material being d % based on the total mass of the positive electrode active material, where 1≤d≤50; and wherein the electrolyte comprises a compound A with a specific structure, a compound B, and a compound C, wherein the compound B comprises a polyether nitrile compound, the compound C comprises 1,3,6-hexanetricarbonitrile; based on the total mass of the electrolyte, the mass content percentage of the compound A is a %, where 0.1≤a≤15; the mass content percentage of the compound B is b %, where 0.1≤b≤5; and the mass content percentage of the compound C is 0.1≤c≤5; and 0.3≤d/(b+c)≤20 and 0<a/(b+c)≤2 are satisfied. In the present application, by using specific amounts of a lithium cobalt oxide material and a lithium nickel cobalt manganese oxide ternary material, and using a compound A, a compound B and a compound C into the electrolyte in combination, the cycling performance and safety performance can be improved while reducing costs and improving the energy density. Specifically, although the use of the lithium cobalt oxide material in combination with the lithium nickel cobalt manganese oxide ternary material can reduce costs and increase energy density, the difference in voltage plateaus between the two materials during cycling of a battery using such a blended positive electrode active material can cause transition metal elements to dissolve out more easily from the positive electrode active material. These metal ions migrate through the electrolyte and are reduced on the surface of the negative electrode, damaging the SEI film and causing more side reactions to occur, thereby deteriorating the battery performance. In the present application, the addition of a compound B and a compound C to the electrolyte for combined use achieve a synergistic effect at the positive electrode, where the intramolecular and intermolecular interaction between ether bonds and cyano groups can improve the polarity of the molecules and provide a strong electron-withdrawing effect, allowing the formation of stable chemical bonds on the surface of the positive electrode. These bonds not only suppress the dissolution of transition metal ions, but also improve the stability and conductivity of the positive electrode interface film, thereby improving the cycling performance of the battery. The use of the compound A cannot only improve the thermal stability of the positive electrode, but also suppress co-intercalation of the compound B and the compound C into the negative electrode, thereby mitigating the volume expansion of the negative electrode. In addition, the compound A can also participate in forming an SEI film having good mechanical properties at the negative electrode. When subjected to stress induced by the expansion of the negative electrode, the SEI film is not easily deformed, thus also suppressing the battery swelling during cycling.

Some of the additional aspects and advantages of the present application will be set forth in the following description, and some will become apparent from the following description, or be learned by practice of the present application.

### DETAILED DESCRIPTION OF EMBODIMENTS

The following examples are provided for a better understanding of the present application, are not limited to the preferred embodiments, and do not limit the content and scope of protection of the present application, and any product that is identical or similar to the present application, derived from the inspiration of the present application or by combining the present application with other features of the prior art, falls within the scope of protection of the present application.

Unless otherwise defined, all technical and scientific terms used herein have the same meanings as those commonly understood by those skilled in the art to which the present application belongs. The terms used herein are merely for the purpose of describing specific embodiments, but are not intended to limit the present application. The terms “comprising” and “having” and any variations thereof in the present application are intended to cover non-exclusive inclusion.

The phrase “embodiment” mentioned herein means that the specific features, structures, or characteristics described in conjunction with the embodiment can be encompassed in at least one embodiment of the present application. The phrase at various locations in the description does not necessarily refer to the same embodiment, or an independent or alternative embodiment exclusive of another embodiment. Those skilled in the art understand explicitly or implicitly that the embodiment described herein may be combined with another embodiment.

The “ranges” disclosed in the present application are defined in the form of lower and upper limits. A given range is defined by selecting a lower limit and an upper limit, and the selected lower and upper limits defining the boundaries of the particular range. Ranges defined in this manner may be inclusive or exclusive, and may be arbitrarily combined, that is, any lower limit may be combined with any upper limit to form a range. In the present application, unless stated otherwise, the numerical range “a-b” denotes an abbreviated representation of any combination of real numbers between a and b, where both a and b are real numbers. For example, the numerical range “0-5” means that all real numbers between “0-5” have been listed herein, and “0-5” is just an abbreviated representation of combinations of these numerical values. In addition, when a parameter is expressed as an integer of ≥2, it is equivalent to disclosing that the parameter can be, for example, an integer of 2, 3, 4, 5, 6, 7, 8, 9, 10, 11, 12, etc.

In the description of the embodiments of the present application, the term “and/or” is merely intended to describe the associated relationship of associated objects, indicating that three relationships can exist. For example, A and/or B may include: only A exists, both A and B exist, and only B exists.

In the description of the embodiments of the present application, the term “at least one” means one or more (including two).

The examples in which experimental steps or conditions are not specified are based on the operations of conventional experimental steps or conditions described in documents in the art. The reagents or instruments used without indicating a manufacturer are all commercially available conventional reagent products.

As described in the Background Art, in order to solve the technical problem that the use of lithium cobalt oxide materials in combination with ternary materials in the prior art may deteriorate the cycling performance and safety performance of the battery, the present application provides the following technical solution.

According to an aspect of the present application, provided is a lithium-ion secondary battery comprising a positive electrode, a negative electrode, and an electrolyte, wherein the positive electrode comprises a positive electrode current collector and an active layer coated on at least one surface of the positive electrode current collector, and the active layer comprises a positive electrode active material, the positive electrode active material comprising a lithium cobalt oxide material and a lithium nickel cobalt manganese oxide ternary material, with the mass content percentage of the lithium nickel cobalt manganese oxide ternary material being d % based on the total mass of the positive electrode active material, where 1≤d≤50; and wherein the electrolyte comprises a compound A, a compound B, and a compound C, wherein the compound B comprises a polyether nitrile compound, the compound C comprises 1,3,6-hexanetricarbonitrile; the compound A has the structure as represented by the following general formula:

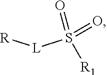

wherein L is O or a linking bond; R is selected from one of C₂-C₆ alkyl which is unsubstituted or substituted with Ra, C₂-C₆ alkenyl which is unsubstituted or substituted with Ra, C₂-C₆ alkynyl which is unsubstituted or substituted with Ra, C₂-C₆ nitrogen-containing heteroaryl which is unsubstituted or substituted with Ra, C₆-C₁₂ aryl which is unsubstituted or substituted with Ra, wherein each substituent Ra is independently selected from fluoro or C₁-C₆ fluoroalkyl; and R₁ is selected from one of fluoro or C₁-C₆ fluoroalkyl;
based on the total mass of the electrolyte, the mass content percentage of the compound A is a %, where 0.1≤a≤15; the mass content percentage of the compound B is b %, where 0.1≤b≤5; and the mass content percentage of the compound C is 0.1≤c≤5; and 0.3≤d/(b+c)≤20 and 0.02<a/(b+c)<2 are satisfied.

As an example, the mass content percentage of the lithium nickel cobalt manganese oxide ternary material may be 1%, 3%, 5%, 10%, 15%, 20%, 25%, 30%, 35%, 40%, 45%, 50% or within the range of the foregoing values, based on the total mass of the positive electrode active material. The mass content percentage of the compound A may be, may be 0.1%, 3%, 5%, 7%, 9%, 10%, 12%, 13%, 15%, or within the range of the foregoing values; the mass content percentage of the compound B may be 0.1%, 0.5%, 0.8%, 1%, 1.2%, 1.5%, 1.7%, 2%, 2.3%, 2.5%, 2.8%, 3%, 3.5%, 4%, 4.5%, 5% or within the range of the foregoing values; and the mass content percentage of the compound C may be 0.1%, 0.5%, 0.8%, 1%, 1.2%, 1.5%, 1.7%, 2%, 2.3%, 2.5%, 2.8%, 3%, 3.5%, 4%, 4.5%, 5% or within the range of the foregoing values, based on the total mass of the electrolyte. The value of d/(b+c) may be 0.3, 0.5, 1, 3, 5, 7, 9, 10, 12, 15, 17, 19, 20 or within the range of the foregoing values. The value of a/(b+c) may be 0.02, 0.1, 0.3, 0.5, 0.7, 0.9, 1, 1.3, 1.5, 1.8, 2, or within the range of the foregoing values.

According to the lithium-ion secondary battery provided in the present application, by using specific amounts of a lithium cobalt oxide material and a lithium nickel cobalt manganese oxide ternary material, and adding a compound A, a compound B and a compound C into the electrolyte for combined use, the cycling performance and safety performance can be improved while reducing costs and improving the energy density. Specifically, in the present application, by using specific amounts of a lithium cobalt oxide material and a lithium nickel cobalt manganese oxide ternary material in combination, the energy density can be improved and the costs can be reduced. However, when this blended positive electrode active material is used, since the voltage plateau of the lithium cobalt oxide material is higher than that of the lithium nickel cobalt manganese oxide ternary material, the difference in voltage plateaus between the two materials during cycling of a battery can cause transition metal elements to dissolve out more easily from the positive electrode material. These metal ions migrate through the electrolyte and are reduced on the surface of the negative electrode, damaging the SEI film and causing more side reactions to occur, thereby deteriorating the battery performance. Therefore, it is necessary to add a compound B and a compound C to the electrolyte. 1,3,6-hexanetricarbonitrile in the compound C has higher chemical stability and reactivity than those of other alkyl nitrile compounds. The three cyano groups in 1,3,6-hexanetricarbonitrile are asymmetrically distributed along the hexane chain, and the molecular configuration that can simultaneously cover different sites on the electrode surface is more flexible, such that a denser adsorption layer is formed. The compound B and the compound C achieve a synergistic effect at the positive electrode, where the intramolecular and intermolecular interaction between ether bonds and cyano groups can improve the polarity of the molecules and provide a strong electron-withdrawing effect, which facilitates the formation of stable chemical bonds on the surface of the positive electrode. These bonds not only suppress the dissolution of transition metal ions but also improve the stability and conductivity of the cathode interface film, thereby improving the cycling performance of the battery. However, the compound B and the compound C can co-intercalate with lithium-ions into the negative electrode, thus disrupting the structural stability of the negative electrode. Because the compound A has a relatively high reduction potential, it can preferentially form a film on the negative electrode of the battery, endowing the SEI film with good ionic conductivity and electronic insulation. The ionic conductivity ensures the de-intercalation of lithium-ions through the SEI film, while the electronic insulation helps to stabilize the potential on the surface of the negative electrode, prevents the generation of local over-potential, and reduces the possibility of reductive decomposition of solvent molecules and co-intercalation thereof. Therefore, the addition of the compound A can suppress the co-intercalation of the compound B and the compound C into the negative electrode. In addition, the compound A can also participate in forming an SEI film having good mechanical properties at the negative electrode. When subjected to stress induced by the expansion of the negative electrode, the SEI film is not easily deformed, thus it can also suppress battery swelling during cycling.

In the present application, if the lithium nickel cobalt manganate ternary material in the positive electrode active material accounts for too little of the total amount of the positive electrode active material, the cost reduction is not significant. When the content thereof is too high, more metal ions will dissolve out at a high voltage, and Li/Ni mixing is more likely to occur, leading to structural damage of the positive electrode and thereby degrading performance such as cycling. The compound A has relatively poor oxidation resistance, and at a high voltage, it is prone to oxidative decomposition, producing harmful substances such as HF, which corrode the electrodes and thus deteriorate the cycling performance of the battery. If the content thereof in the electrolyte is too low, the battery performance is not significantly improved. When the contents of compounds B and C are too low, they cannot provide adequate protection for the positive electrode and suppress problems such as the dissolution of metal ions from the positive electrode. Conversely, when the content is too high, a large number of free compounds that do not protect the positive electrode are subjected to solvent co-intercalation in the negative electrode, which affects the structural stability of the negative electrode and thus leads to deterioration of cycling performance and safety performance. When the content of the lithium nickel cobalt manganese oxide ternary material to contents of the compound B and the compound C in the positive electrode material, i.e., d/(b+c) reaches a certain ratio, it enables provide sufficient protection to the positive electrode while reducing the risk of solvent co-intercalation in the negative electrode. When the content of the compound A to contents of the compound B and the compound C, i.e., a/(b+c) satisfies a certain ratio, the negative electrode can be sufficiently protected to inhibit solvent molecule co-intercalation.

In some optional embodiments, the compound A has any of the structures as represented by the following formulae:

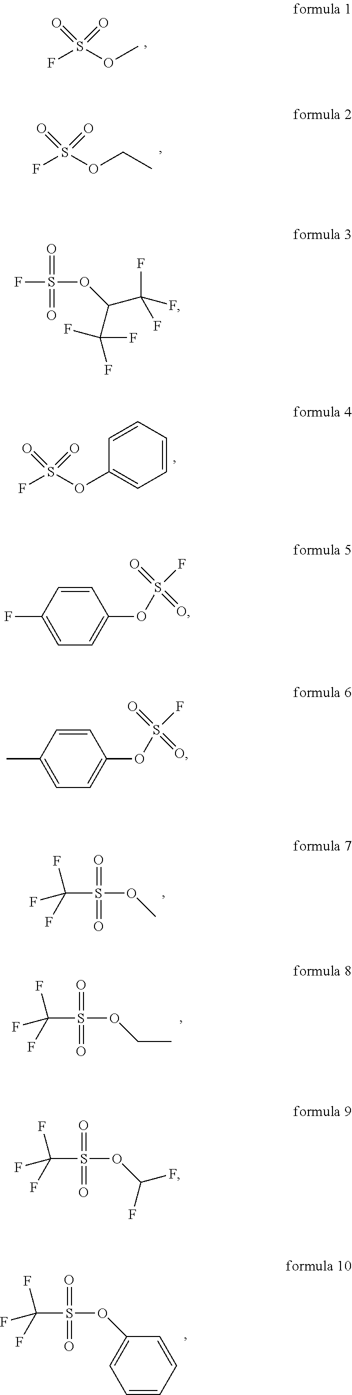

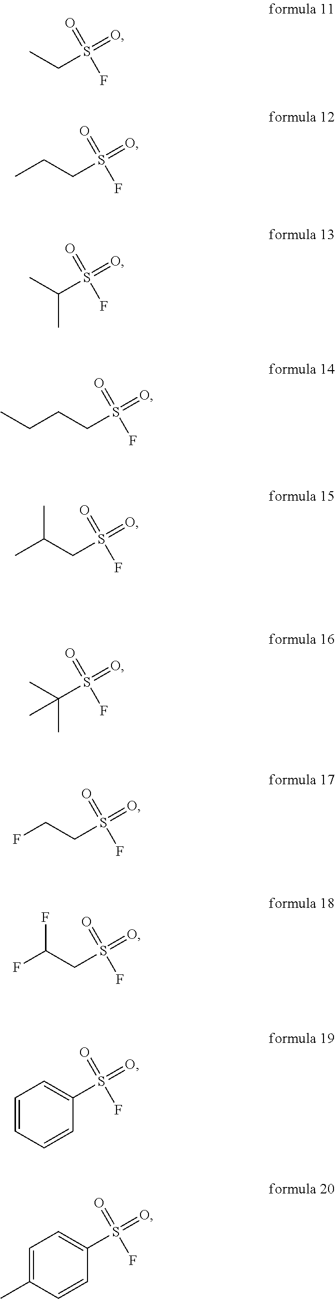

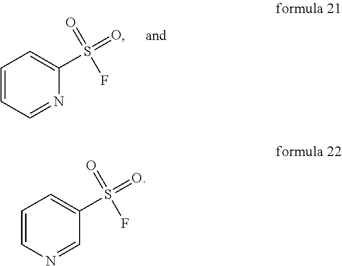 [SMILES: O=S(=O)(F)c1ccccn1 ; O=S(=O)(F)c1cccnc1]

In some optional embodiments, the compound B comprises at least one of 1,2,3,4,5-penta(2-cyanoethoxy)pentane (CAS: 55726-81-3), ethylene glycol di(2-cyanoethyl) ether (CAS: 59086-77-0), diethylene glycol di(2-cyanoethyl) ether

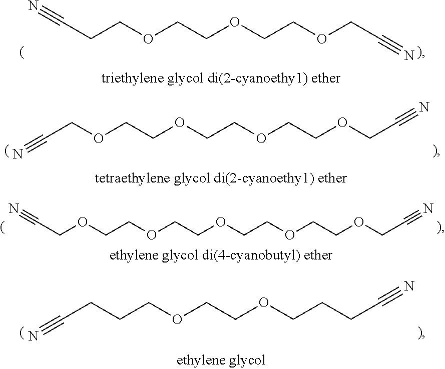 [SMILES: N#CCCOCCOCCOCC#N ; N#CCOCCOCCOCCOCC#N ; N#CCOCCOCCOCCOCCOCC#N ; N#CCCCOCCOCCCC#N]

bis(propionitrile) ether (DENE, CAS: 3386-87-6), and 1,2,3-tris(2-cyanoxy)propane (TCEP, CAS: 2465-93-2).

In some optional embodiments, the compound C further comprises at least one of benzonitrile, p-tolunitrile, 3,5-difluorobenzonitrile, adiponitrile (AND), succinonitrile (SN), 1,2,6-hexanetricarbonitrile, 3,5-bis(trifluoromethyl)benzonitrile, ethoxypentafluorocyclotriphosphazene, and hexafluorocyclotriphosphazene.

In some optional embodiments, the electrolyte further comprises a lithium salt, in a mass content percentage of 10-30%, based on the total mass of the electrolyte; The lithium salt comprises at least one of lithium hexafluorophosphate, lithium bis(trifluoromethanesulfonyl)imide, lithium difluorophosphate (LiPO₂F₂), lithium difluoro(oxalato)borate (LiDFOB), lithium bis(fluorosulfonyl)imide (LiFSI), lithium difluorobis(oxalato)phosphate, lithium tetrafluoroborate, lithium bis(oxalato)borate, lithium hexafluoroantimonate, lithium hexafluoroarsenate, lithium bis(trifluoromethylsulfonyl)imide, lithium bis(pentafluoroethylsulfonyl)imide, lithium tris(trifluoromethylsulfonyl)methide or lithium bis(trifluoromethylsulfonyl)imide, lithium trifluoromethanesulfinate, and lithium hexafluorozirconate (Li₂ZrF₆).

Optionally, the lithium salt comprises lithium hexafluorophosphate (LiPF₆) and lithium bis(trifluoromethanesulfonyl)imide (LiTFSI), with the mass content percentage of lithium hexafluorophosphate being e %, and the mass content percentage of lithium bis(trifluoromethanesulfonyl)imide being f %, based on the total mass of the electrolyte, and 8≤e≤20, 0.5≤f≤10, and 1≤e/f≤5 are satisfied. As an example, the mass content percentage of lithium hexafluorophosphate may be, may be 8%, 10%, 12%, 15%, 17%, 19%, 20%, or within the range of the foregoing values; The mass content percentage of lithium bis(trifluoromethanesulfonyl)imide can be 1%, 1.5%, 2%, 2.5%, 3%, 3.5%, 4%, 4.5%, 5%, 6%, 8%, 10% or within the range of the foregoing values. The value of e/f may be 1, 1.5, 2, 2.5, 3, 3.5, 4, 4.5, 5, or within the range of the foregoing values.

In the present application, the solvation structure of the electrolyte can be optimized by using lithium salts of LiPF₆ and LiTFSI in combination and by adjusting and controlling the ratio of LiPF₆ to LiTFSI. This is because the anion of LiTFSI (TFSI⁻) binds more readily with Li⁺ than the anion of LiPF₆ (PF₆⁻), a more stable solvation structure is provided. The optimization of this structure can improve the oxidative stability of the electrolyte, reduce the oxidation of the compound A, further improve the stability of both the positive and negative electrodes, and ultimately lead to further optimization of the cycling performance of the battery.

In some optional embodiments, the electrolyte further comprises ethylene carbonate (EC), in a mass content percentage of g % based on the total mass of the electrolyte, and 0.1<g≤20 and 0.1≤a/g≤0.8 are satisfied. As an example, the mass content percentage of ethylene carbonate in the electrolyte may be 0.1%, 1%, 3%, 5%, 7%, 9%, 10%, 12%, 14%, 15%, 16%, 18%, 20% or within the range of the foregoing values, based on the total mass of the electrolyte. The value of a/g may be 0.1, 0.2, 0.3, 0.4, 0.5, 0.6, 0.7, 0.8, or within the range of the foregoing values.

In the present application, ethylene carbonate and compound A synergistically form an SEI film on the surface of the negative electrode, which is interwoven with organic and inorganic components. The SEI film not only has good flexibility and elasticity but also possesses sufficient mechanical strength and hardness, such that the SEI film can better accommodate the volume changes of the battery during charging and discharging, the battery swelling during cycling is improved, and thereby the cycling life of the battery is improved. As the primary solvent for dissolving the lithium salt, if the content of ethylene carbonate is too low, the solubility of the lithium salt is reduced. Conversely, if the content is too high, there is a risk of decomposition and gas generation, and an SEI film with an excessive organic components may be formed at the negative electrode, such that the mechanical strength and hardness of the SEI film are reduced, the electronic insulation of the SEI film is poorer, and in turn the further improvement of the cycling performance of the battery is affected. When g/a satisfies a certain ratio, the ratio of organic and inorganic components in the SEI film can be adjusted, allowing both the mechanical strength and elasticity of the SEI film to meet the performance requirements for the battery. However, when this ratio exceeds the range, the content of a single component in the SEI film will be too high, resulting in insufficient elasticity of the SEI film to accommodate the expansion of the negative electrode or poor electronic insulation causing solvent co-intercalation, etc., which in turn affects the further improvement of the cycling performance of the battery.

In some optional embodiments, the electrolyte also comprises a sulfur-containing additive, in a mass content percentage of h % based on the total mass of the electrolyte, and 0.1<h<6 and 0.3≤h/a≤3 are satisfied; As an example, the mass content percentage of the sulfur-containing additive in the electrolyte may be 0.1%, 0.5%, 1%, 1.5%, 2%, 2.5%, 3%, 3.5%, 4%, 4.5%, 5%, 5.5%, 6% or within the range of the foregoing values, based on the total mass of the electrolyte. The value of h/a may be 0.3, 0.5, 0.8, 1, 1.2, 1.5, 1.7, 2, 2.2, 2.5, 2.8, 3 or within the range of the foregoing values.

In the present application, the sulfur-containing compound has a lower reduction potential than the compound A and the compound G, enabling the formation of a stable sulfur-containing compound film layer outside the SEI layer formed by the compound A and/or the compound G. The formation of the film suppresses side reactions resulting from direct contact between the electrode and the electrolyte and prevents the decomposition of the electrolyte, and the formed film has good ionic conductivity and electronic insulation, such that the damage to the negative electrode structure caused by solvent co-intercalation is reduced, thus further improving the cycling and hot box safety performance of the battery. If the content of sulfur-containing compounds is too low, the improvement in battery performance is not significant. Conversely, if the content is too high, although the hot box safety performance of the battery can be substantially improved, the impedance of the formed SEI film will also increase, affecting the cycling performance. By controlling the ratio h/a, the SEI film on the negative electrode can have improved hot box safety performance of the battery but also low interface impedance, thereby enhancing the cycling performance.

Optionally, the sulfur-containing additive has any of the structures as represented by the following formulae:

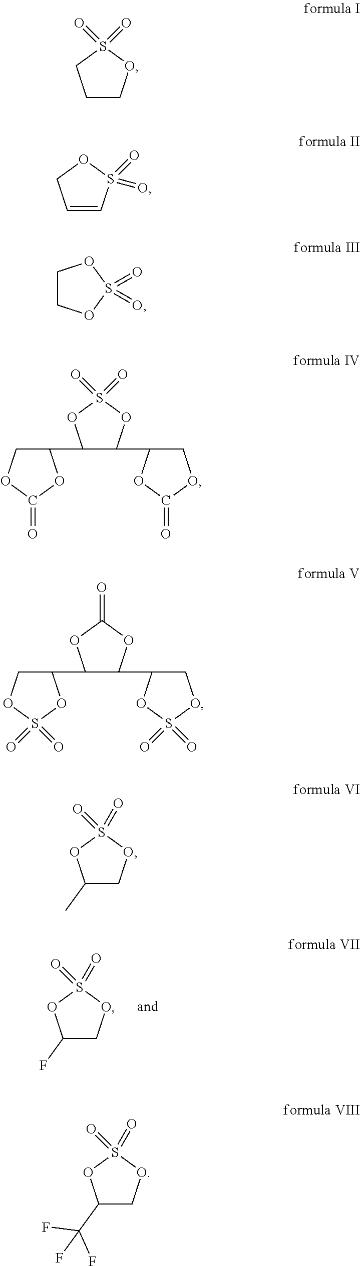

In some optional embodiments, the positive electrode active material further comprises an aluminum element, in a mass content percentage of i % based on the total mass of the positive electrode active material, where 0.3≤i≤1.2. As an example, the mass content percentage of the aluminum element may be 0.3%, 0.4%, 0.5%, 0.6%, 0.7%, 0.8%, 0.9%, 1%, 1.1%, 1.2% or within the range of the foregoing values, based on the total mass of the positive electrode active material.

In the present application, the aluminum element may be doped into the lithium cobalt oxide material, into the lithium nickel cobalt manganese oxide ternary material, or doped into both, provided that the content of the aluminum element in the positive electrode active material is controlled within the above range. The aluminum element has a radius similar to that of cobalt, and is electrochemically inert, which can stabilize the structure of the ternary material. Especially at a high voltage, aluminum forms stable bonds with oxygen, demonstrating good structural stability and lattice strain, thereby improving the cycling stability of the battery. Furthermore, since the Al element has higher chemical activity compared to other doping elements in the positive electrode material, some of the aluminum elements tend to enrich on the surface of the positive electrode active material during the synthesis of the positive electrode material. Due to the inherent conductivity, the aluminum element can provide good interface contact between the internal particles of the positive electrode active material, thereby enhancing the rate performance of the material. Additionally, the aluminum elements enriched on the surface of the positive electrode active material are easily oxidized to form Al₂O₃, forming a protective layer on the surface of the electrode, which suppresses side reactions between the electrode and the electrolyte and effectively inhibits the oxidative activity of cations on the surface of the material at a high voltage. Together with the compound B and the compound C, the aluminum elements mitigate the side reactions between the material and the organic electrolyte at a high voltage, stabilizes the surface of the material, and further improves the cycling life of the battery. If the content of aluminum is too low, the effect on further stabilizing the structure of the positive electrode material is not significant. Conversely, if the content is too high, it will affect the energy density of the material, and the Al₂O₃ layer formed on the electrode surface will substantially increase the interface impedance, which will affect the further improvement of the cycling performance and rate performance.

In some optional embodiments, the negative electrode comprises a negative electrode active material, which comprises graphite and a silicon-carbon composite material, with the content percentage of the silicon element in the silicon-carbon composite material being j % of the negative electrode active material, where 0.5≤j≤35. As an example, the content percentage of the silicon element in the silicon-carbon composite material may be 0.5%, 1%, 3%, 5%, 7%, 9%, 10%, 15%, 20%, 25%, 30%, 35% or within the range of the foregoing values, relative to the negative electrode active material. In the present application, the use of a silicon-carbon composite material, compared to a carbon-based negative electrode material, enables the storage of more lithium-ions, thereby increasing the energy density of the battery. If the content of silicon is too low, it cannot improve the energy density of the battery. Conversely, if the content is too high, the negative electrode will expand greatly, and the electrolyte will be consumed to repair the damaged SEI film during the cycling, which will lead to the decline of cycling performance.

Optionally, 0.1≤j/a≤10 is satisfied. As an example, the value of j/a can be 0.1, 0.5, 1, 1.5, 2, 2.5, 3, 3.5, 4, 4.5, 5, 5.5, 6, 7, 8, 9, 10, or within the range of the foregoing values. When the content of the compound A and the content of silicon in the negative electrode satisfy the above relational expression, the SEI film formed on the surface of the negative electrode of the battery has sufficient strength and elasticity. During cycling, as the negative electrode expands and contracts, the SEI film can accommodate the volume changes of the negative electrode without being prone to cracking, thus further improving the cycling performance of the battery.

According to a yet another aspect of the present application, provided is a power consuming device comprising the lithium-ion secondary battery as described above.

It will be appreciated by those skilled in the art that the lithium-ion secondary battery provided in the present application further comprises structural components such as a separator and a housing. During the charging and discharging process of the battery, lithium-ions are intercalated and de-intercalated back and forth between the positive electrode and the negative electrode, the electrolyte functions to conduct ions between the positive electrode and the negative electrode, and the separator is provided between the positive electrode and the negative electrode, mainly prevents positive and negative electrodes from short-circuiting, and enables the passage of lithium-ions.

As an example, the material and composition of the positive electrode and the preparation method therefor used in the lithium-ion battery of the present application may include any of the techniques disclosed in the prior art.

As an example, the negative electrode includes a negative electrode current collector and a negative electrode active material layer, wherein the negative electrode current collector has two opposite surfaces in its own thickness direction, and the negative electrode active material layer is provided on either or both of the two opposite surfaces of the negative electrode current collector. The materials and composition of the negative electrode and the preparation method therefor used in the lithium-ion battery of the present application may include any of the techniques disclosed in the prior art.

The material and shape of the separator used in the lithium-ion secondary battery of the present application is not particularly limited and may any of the techniques disclosed in the prior art.

The electrolyte used in the lithium-ion secondary battery of the present application may also include any of the techniques disclosed in the prior art.

The method for preparing the lithium-ion secondary battery in the present application is not specifically limited, and lithium-ion secondary batteries can be prepared using conventional methods in the art. For example, the positive electrode, the separator, and the negative electrode are sequentially stacked with the separator positioned between the positive electrode and the negative electrode, the assembly is subjected to a stacking or winding process to obtain a cell, and then the cell is subjected to procedures of baking, electrolyte injection, formation, packaging, etc., to obtain the lithium-ion secondary battery of the present application.

It is understood that in the power consuming device provided by the present application, the lithium-ion secondary battery can be used as a power supply for the power consuming device, or can also be used as an energy storage unit for the power consuming device. The power consuming device may be, but is not limited to, a mobile device (e.g., a mobile phone, a laptop computer, etc.), an electric vehicle (e.g., a pure electric vehicle, a hybrid electric vehicle, a plug-in hybrid electric vehicle, an electric bicycle, an electric scooter, an electric golf cart, an electric truck, etc.), an electric train, ship and satellite, an energy storage system, and the like.

The power consuming device shares the same advantages over the prior art as the aforementioned lithium-ion secondary battery, which will not be repeated here.

The present application will be described below with reference to specific examples. It should be noted that these examples are merely illustrative and do not limit the present application in any way.

### Example 1

The present example provided a lithium-ion secondary battery, and the specific composition thereof and preparation method therefor were as follows.

### 1) Preparation of Positive Electrode

A positive electrode active material of lithium cobalt oxide (LiCoO₂), a nickel-cobalt-manganese ternary material (NCM811), polyvinylidene fluoride (PVDF), SP (super P) and carbon nanotubes (CNTs) were mixed in a mass ratio of 57.6:38.4:2:1.5:0.5, N-methylpyrrolidone (NMP) was added, and the mixture was stirred under the action of a vacuum stirrer until the mixed system became a positive electrode active slurry with a uniform flowability. The positive electrode active slurry was uniformly coated onto both surfaces of an aluminum foil. The coated aluminum foil was dried, and then subjected to rolling and slitting to obtain the desired positive electrode, which may have an areal density of 0.010-0.018 g/cm² and a compaction density of 3.8-4.5 g/cm³. In this example, the areal density of the positive electrode was 0.016 g/cm², and the compaction density was 4.2 g/cm³.

### 2) Preparation of Negative Electrode

A negative electrode active material of artificial graphite, sodium carboxymethyl cellulose (CMC-Na), a styrene-butadiene rubber, conductive carbon black (SP), and single-walled carbon nanotubes (SWCNTs) were mixed in a mass ratio of 94.5:2.5:1.5:1:0.5, and added with deionized water and stirred under the action of a vacuum stirrer to obtain a negative electrode active slurry. The negative electrode active slurry was uniformly coated onto both surfaces of a copper foil. The coated copper foil was air-dried at room temperature, then transferred to an oven and dried at 80° C. for 10 h, and then subjected to cold pressing and slitting to obtain the negative electrode, which may have an areal density of 0.004-0.007 g/cm² and a compaction density of 1.65-1.78 g/cm³. In this example, the areal density of the positive electrode was 0.0055 g/cm², and the compaction density was 1.7 g/cm³.

### 3) Preparation of Electrolyte

In a glove box filled with argon (H₂O<0.1 ppm, O₂<0.1 ppm), propylene carbonate (PC)/propyl propionate (PP)/ethyl propionate (EP) were mixed uniformly at a mass ratio of 20:20:50. Subsequently, thoroughly dried lithium hexafluorophosphate (LiPF₆) was quickly added to the mixture in an amount of e % relative to the total mass of the electrolyte. After dissolution, a compound A, a compound B, and a compound C were added in amounts of a %, b %, and c %, respectively, based on the total mass of the electrolyte. The specific amounts and compounds were shown in Table 1. After stirring until uniform, the mixture passed the tests of moisture and free acid and was confirmed to meet specifications, then the desired electrolyte was obtained.

### 4) Assembly of Battery

The positive electrode of step 1), the negative electrode of step 2), and a separator were stacked in the order of the positive electrode, the separator (a polypropylene separator with a thickness of 8 m), and the negative electrode, followed by winding to obtain a cell. The cell was placed into an aluminum foil outer package, and the electrolyte of step 3) was injected into the outer package, and then vacuum-packaging, leaving to stand, forming, shaping, sorting and other steps were performed to obtain a lithium-ion secondary battery with a capacity of 6 Ah. In the present application, the charge/discharge voltage range of the battery was 3.0-4.55 V.

### Example 2

This example provided a lithium-ion secondary battery, differing from Example 1 in that the electrolyte also comprised g % of ethylene carbonate, see Table 1 for details.

### Example 3

This example provided a lithium-ion secondary battery, differing from Example 1 in that the electrolyte also comprised h % of a sulfur-containing additive, see Table 1 for details.

### Example 4

This example provided a lithium-ion secondary battery, differing from Example 1 in that the lithium salt in the electrolyte was a mixture of lithium hexafluorophosphate and lithium bis(trifluoromethanesulfonyl)imide, with mass content percentages of e % and f % respectively based on the total mass of the electrolyte, see Table 1 for details.

### Example 5

This example provided a lithium-ion secondary battery, differing from Example 1 in that the positive electrode active material was doped with i % of an aluminum element. In this embodiment, both lithium cobalt oxide and NCM811 comprised i % of an aluminum element, see Table 1 for details.

### Example 6

This example provided a lithium-ion secondary battery, differing from Example 1 in that the composition of the negative electrode active slurry was different. In this example, the negative electrode active slurry comprised artificial graphite, a silicon-carbon material, sodium carboxymethyl cellulose (CMC-Na), a styrene-butadiene rubber, conductive carbon black (SP), and single-walled carbon nanotubes (SWCNTs) in a mass ratio of 54.5:40:2.5:1.5:1:0.5.

### Example 7

The present example provided a lithium-ion secondary battery, and the specific composition thereof and preparation method therefor were as follows.

### 1) Preparation of Positive Electrode

A positive electrode active material of lithium cobalt oxide (LiCoO₂), a nickel-cobalt-manganese ternary material (NCM811), polyvinylidene fluoride (PVDF), SP (super P) and carbon nanotubes (CNTs) were mixed in a mass ratio of 57.6:38.4:2:1.5:0.5, wherein in this example, both lithium cobalt oxide and NCM811 contained i % of an aluminum element; N-methylpyrrolidone (NMP) was added, and the mixture was stirred under the action of a vacuum stirrer until the mixed system became a positive electrode active slurry with a uniform flowability. The positive electrode active slurry was uniformly coated onto both surfaces of an aluminum foil. The coated aluminum foil was dried, and then subjected to rolling and slitting to obtain the desired positive electrode. In this example, the areal density and compaction density of the positive electrode were the same as those in Example 1.

### 2) Preparation of Negative Electrode

A negative electrode active material of artificial graphite, a silicon-carbon material, sodium carboxymethyl cellulose (CMC-Na), a styrene-butadiene rubber, conductive carbon black (SP), and single-walled carbon nanotubes (SWCNTs) were mixed in a mass ratio of 54.5:40:2.5:1.5:1:0.5, and added with deionized water and stirred under the action of a vacuum stirrer to obtain a negative electrode active slurry. The negative electrode active slurry was uniformly coated onto both surfaces of a copper foil. The coated copper foil was air-dried at room temperature, then transferred to an oven and dried at 80° C. for 10 h, and then subjected to cold pressing and slitting to obtain the negative electrode. In this example, the areal density and compaction density of the negative electrode in this example were the same as those in Example 1.

### 3) Preparation of Electrolyte

In a glove box filled with argon (H₂O<0.1 ppm, O₂<0.1 ppm), propylene carbonate (PC)/propyl propionate (PP)/ethyl propionate (EP) were mixed uniformly at a mass ratio of 20:20:50. Then thoroughly dried lithium hexafluorophosphate (LiPF₆) and lithium bis(trifluoromethanesulfonyl)imide (LiTFSI), corresponding to e % and f % of the total mass of the electrolyte, respectively, were quickly added thereto, and after dissolution, a compound A, a compound B, a compound C, ethylene carbonate (EC), and a sulfur-containing additive corresponding to a %, b %, c %, g %, and h % of the total mass of the electrolyte, respectively, were added; The specific amounts and compounds were shown in Table 1. After stirring until uniform, the mixture passed the tests of moisture and free acid and was confirmed to meet specifications, then the desired electrolyte was obtained.

### 4) Assembly of Battery

The positive electrode of step 1), the negative electrode of step 2), and a separator were stacked in the order of the positive electrode, the separator (a polypropylene separator with a thickness of 8 m), and the negative electrode, followed by winding to obtain a cell. The cell was placed into an aluminum foil outer package, and the electrolyte of step 3 was injected into the outer package, and then vacuum-packaging, leaving to stand, forming, shaping, sorting and other steps were performed to obtain a lithium-ion secondary battery with a capacity of 6 Ah. In the present application, the charge/discharge voltage range of the battery was 3.0-4.55 V.

### Examples 8-38

This example provided a lithium-ion secondary battery, differing from Example 7 in that the composition of the electrolyte, the positive electrode active material and the negative electrode active material were different. See Table 1 for details.

### Example 39

This example provided a lithium-ion secondary battery, differing from Example 1 in that the electrolyte further comprised 1% of succinonitrile based on the total mass of the electrolyte.

### Comparative Examples 1-7

Compared with Example 7, Comparative Examples 1-7 differed in the composition of the electrolyte, the positive electrode active material, and the negative electrode active material. In Comparative Example 4, adiponitrile was used instead of HTCN, and Comparative Examples 5-7 did not satisfy the relational expressions d/(b+c) and/or a/(b+c); see table 1 for details.

TABLE 1

| | | | | | | | | | | | | Content | Content |
|---|---|---|---|---|---|---|---|---|---|---|---|---|---|
| | | | | | | | | | | | Content | of | of |
| | | Con- | | | | Per- | | Con- | | | of | silicon | alu- |
| | Structure | tent | Structure | | Com- | centage | | tent | Com- | | sulfur- | in | minum |
| | of | of | of | | pound | of | Content | of | pound | Structure of | con- | negative | in |
| | com- | com- | com- | Com- | C- | ternary | of | LiT | G- | sulfur- | taining | elec- | positive |
| | pound | pound | pound | pound | HTC | material, | LiPF6e/ | FSIf/ | EC/g | containing | additive, | trode | electrode |
| Group | A | A/% | B | B/% | N/% | d/% | % | % | % | additive | h% | j% | i/% |
| Example | Formula | 6 | DEN | 0.5 | 3 | 40 | 20 | | 00 | / | 0 | 100 | |
| 1 | 4 | | E | | | | | | | | | | |
| Example | Formula | 6 | DEN | 0.5 | 3 | 40 | 20 | 0 | 10 | / | 0 | 0 | 0 |
| 2 | 4 | | E | | | | | | | | | | |
| Example | Formula | 6 | DEN | 0.5 | 3 | 40 | 20 | 0 | 0 | Formulae | 4 | 0 | 0 |
| 3 | 4 | | E | | | | | | | I + IV, 1:3 | | | |
| Example | Formula | 6 | DEN | 0.5 | 3 | 40 | 13 | 7 | 0 | / | 0 | 0 | 0 |
| 4 | 4 | | E | | | | | | | | | | |
| Example | Formula | 6 | DEN | 0.5 | 3 | 40 | 20 | 0 | 0 | / | 0 | 0 | 0.6 |
| 5 | 4 | | E | | | | | | | | | | |
| Example | Formula | 6 | DEN | 0.5 | 3 | 40 | 20 | 0 | 0 | / | 0 | 20 | 0 |
| 6 | 4 | | E | | | | | | | | | | |
| Example | Formula | 6 | DEN | 0.5 | 3 | 40 | 13 | 7 | 10 | Formulae | 4 | 20 | 0.6 |
| 7 | 4 | | E | | | | | | | I + IV, 1:3 | | | |
| Example | Formula | 6 | DEN | 0.5 | 3 | 40 | 13 | 7 | 10 | Formulae | 4 | 20 | 0.6 |
| 8 | 1 | | E | | | | | | | I + IV, 1:3 | | | |
| Example | Formula | 6 | DEN | 0.5 | 3 | 40 | 13 | 7 | 10 | Formulae | 4 | 20 | 0.6 |
| 9 | 3 | | E | | | | | | | I + IV, 1:3 | | | |
| Example | Formula | 6 | DEN | 0.5 | 3 | 40 | 13 | 7 | 10 | Formulae | 4 | 20 | 0.6 |
| 10 | 10 | | E | | | | | | | I + IV, 1:3 | | | |
| Example | Formula | 6 | DEN | 0.5 | 3 | 40 | 13 | 7 | 10 | Formulae | 4 | 20 | 0.6 |
| 11 | 11 | | E | | | | | | | I + IV, 1:3 | | | |
| Example | Formula | 6 | DEN | 0.5 | 3 | 40 | 13 | 7 | 10 | Formulae | 4 | 20 | 0.6 |
| 12 | 18 | | E | | | | | | | I + IV, 1:3 | | | |
| Example | Formula | 6 | DEN | 0.5 | 3 | 40 | 13 | 7 | 10 | Formulae | 4 | 20 | 0.6 |
| 13 | 19 | | E | | | | | | | I + IV, 1:3 | | | |
| Example | Formula | 0.1 | DEN | 0.5 | 3 | 40 | 13 | 7 | 10 | Formulae | 4 | 20 | 0.6 |
| 14 | 4 | | E | | | | | | | I + IV, 1:3 | | | |
| Example | Formula | 15 | DEN | 4.5 | 3 | 40 | 13 | 7 | 10 | Formulae | 4 | 20 | 0.6 |
| 15 | 4 | | E | | | | | | | I + IV, 1:3 | | | |
| Example | Formula | 6 | TCE | 4.5 | 3 | 40 | 13 | 7 | 10 | Formulae | 4 | 20 | 0.6 |
| 16 | 4 | | P | | | | | | | I + IV, 1:3 | | | |
| Example | Formula | 6 | DEN | 2 | 3 | 40 | 13 | 7 | 10 | Formulae | 4 | 20 | 0.6 |
| 17 | 4 | | E | | | | | | | I + IV, 1:3 | | | |
| Example | Formula | 6 | DEN | 5 | 3 | 40 | 13 | 7 | 10 | Formulae | 4 | 20 | 0.6 |
| 18 | 4 | | E | | | | | | | I + IV, 1:3 | | | |
| Example | Formula | 6 | DEN | 3 | 0.1 | 40 | 13 | 7 | 10 | Formulae | 4 | 20 | 0.6 |
| 19 | 4 | | E | | | | | | | I + IV, 1:3 | | | |
| Example | Formula | 6 | DEN | 0.5 | 5 | 40 | 13 | 7 | 10 | Formulae | 4 | 20 | 0.6 |
| 20 | 4 | | E | | | | | | | I + IV, 1:3 | | | |
| Example | Formula | 6 | DEN | 0.5 | 2.5 | 1 | 13 | 7 | 10 | Formulae | 4 | 20 | 0.6 |
| 21 | 4 | | E | | | | | | | I + IV, 1:3 | | | |
| Example | Formula | 6 | DEN | 0.5 | 3 | 50 | 13 | 7 | 10 | Formulae | 4 | 20 | 0.6 |
| 22 | 4 | | E | | | | | | | I + IV, 1:3 | | | |
| Example | Formula | 6 | DEN | 0.5 | 3 | 40 | 8 | 7 | 10 | Formulae | 4 | 20 | 0.6 |
| 23 | 4 | | E | | | | | | | I + IV, 1:3 | | | |
| Example | Formula | 6 | DEN | 0.5 | 3 | 40 | 6 | 14 | 10 | Formulae | 4 | 20 | 0.6 |
| 24 | 4 | | E | | | | | | | I + IV, 1:3 | | | |
| Example | Formula | 6 | DEN | 0.5 | 3 | 40 | 13 | 0.5 | 10 | Formulae | 4 | 20 | 0.6 |
| 25 | 4 | | E | | | | | | | I + IV, 1:3 | | | |
| Example | Formula | 6 | DEN | 0.5 | 3 | 40 | 13 | 10 | 10 | Formulae | 4 | 20 | 0.6 |
| 26 | 4 | | E | | | | | | | I + IV, 1:3 | | | |
| Example | Formula | 6 | DEN | 0.5 | 3 | 40 | 13 | 7 | 20 | Formulae | 4 | 20 | 0.6 |
| 27 | 4 | | E | | | | | | | I + IV, 1:3 | | | |
| Example | Formula | 6 | DEN | 0.5 | 3 | 40 | 13 | 7 | 22 | Formulae | 4 | 20 | 0.6 |
| 28 | 4 | | E | | | | | | | I + IV, 1:3 | | | |
| Example | Formula | 6 | DEN | 0.5 | 3 | 40 | 13 | 7 | 10 | Formula | 4 | 20 | 0.6 |
| 29 | 4 | | E | | | | | | | II | | | |
| Example | Formula | 6 | DEN | 0.5 | 3 | 40 | 13 | 7 | 10 | Formula | 4 | 20 | 0.6 |
| 30 | 4 | | E | | | | | | | VII | | | |
| Example | Formula | 6 | DEN | 0.5 | 3 | 40 | 13 | 7 | 10 | Formulae | 0.1 | 20 | 0.6 |
| 31 | 4 | | E | | | | | | | I + IV, 1:3 | | | |
| Example | Formula | 6 | DEN | 0.5 | 3 | 40 | 13 | 7 | 10 | Formulae | 6 | 20 | 0.6 |
| 32 | 4 | | E | | | | | | | I + IV, 1:3 | | | |
| Example | Formula | 6 | DEN | 0.5 | 3 | 40 | 13 | 7 | 10 | Formulae | 6.5 | 20 | 0.6 |
| 33 | 4 | | E | | | | | | | I + IV, 1:3 | | | |
| Example | Formula | 6 | DEN | 0.5 | 3 | 40 | 13 | 7 | 10 | Formulae | 4 | 0.5 | 0.6 |
| 34 | 4 | | E | | | | | | | I + IV, 1:3 | | | |
| Example | Formula | 6 | DEN | 0.5 | 3 | 40 | 13 | 7 | 10 | Formulae | 4 | 35 | 0.6 |
| 35 | 4 | | E | | | | | | | I + IV, 1:3 | | | |
| Example | Formula | 6 | DEN | 0.5 | 3 | 40 | 13 | 7 | 10 | Formulae | 4 | 20 | 0.3 |
| 36 | 4 | | E | | | | | | | I + IV, 1:3 | | | |
| Example | Formula | 6 | DEN | 0.5 | 3 | 40 | 13 | 7 | 10 | Formulae | 4 | 20 | 1.2 |
| 37 | 4 | | E | | | | | | | I + IV, 1:3 | | | |
| Example | Formula | 6 | DEN | 0.5 | 3 | 40 | 13 | 7 | 10 | Formulae | 4 | 20 | 0.2 |
| 38 | 4 | | E | | | | | | | I + IV, 1:3 | | | |
| Com- | Formula | 0 | DEN | 0.5 | 3 | 40 | 13 | 7 | 10 | Formulae | 4 | 20 | 0.6 |
| parative | 4 | | E | | | | | | | I + IV, 1:3 | | | |
| example | | | | | | | | | | | | | |
| 1 | | | | | | | | | | | | | |
| Com- | Formula | 6 | DEN | 0 | 3 | 40 | 13 | 7 | 10 | Formulae | 4 | 20 | 0.6 |
| parative | 4 | | E | | | | | | | I + IV, 1:3 | | | |
| Example | | | | | | | | | | | | | |
| 2 | | | | | | | | | | | | | |
| Com- | Formula | 6 | DEN | 0.5 | 0 | 40 | 13 | 7 | 10 | Formulae | 4 | 20 | 0.6 |
| parative | 4 | | E | | | | | | | I + IV, 1:3 | | | |
| Example | | | | | | | | | | | | | |
| 3 | | | | | | | | | | | | | |
| Com- | Formula | 6 | DEN | 0.5 | 3 | 40 | 13 | 7 | 10 | Formulae | 4 | 20 | 0.6 |
| parative | 4 | | E | | | | | | | I + IV, 1:3 | | | |
| Example | | | | | | | | | | | | | |
| 4 | | | | | | | | | | | | | |
| Com- | Formula | 15 | DEN | 0.5 | 3 | 40 | 13 | 7 | 10 | Formulae | 4 | 20 | 0.6 |
| parative | 4 | | E | | | | | | | I + IV, 1:3 | | | |
| Example | | | | | | | | | | | | | |
| 5 | | | | | | | | | | | | | |
| Com- | Formula | 6 | DEN | 0.5 | 0.1 | 40 | 13 | 7 | 10 | Formulae | 4 | 20 | 0.6 |
| parative | 4 | | E | | | | | | | I + IV, 1:3 | | | |
| Example | | | | | | | | | | | | | |
| 6 | | | | | | | | | | | | | |
| Com- | Formula | 3.2 | DEN | 1.5 | 0.1 | 40 | 13 | 7 | 10 | Formulae | 4 | 20 | 0.6 |
| parative | 4 | | E | | | | | | | I + IV, 1:3 | | | |
| Example | | | | | | | | | | | | | |
| 7 | | | | | | | | | | | | | |

### Performance Test

### 1. Cycling Test at 25° C.

At 25° C., the batteries obtained from each example and comparative example were charged at a constant current of 3 C to a voltage of 4.55V, then charged at a constant voltage of 4.55V until the current was 0.05 C and allowed to stand for 5 min; the batteries were then discharged at a constant current of 3 C to a voltage of 3.0 V. This was a charge/discharge cycle. The discharge capacity in the first cycle was tested and recorded as x mAh, and the discharge capacity in the Nth cycle was tested and recorded as y mAh. The cycling capacity retention rate R in the Nth cycle was obtained by dividing the capacity in the Nth cycle by that in the first cycle, i.e., R=y/x×10000. The number of cycles of the battery at which the cycling capacity retention rate reached 800% was recorded.

### 2. Cycling Swelling Test

At 25° C., the batteries obtained from each example and comparative example were tested for their thickness, recorded as d1. Then the batteries were charged at a constant current of 3 C to a voltage of 4.55V, charged at a constant voltage of 4.55V until the current was 0.05 C, allowed to stand for 5 min, and discharged at a constant current of 3 C to a voltage of 3.0V. This was a charge/discharge cycle. The thickness after 500T cycles was recorded as d2, and the thickness change rate D was calculated as D=(d2−d1)/d1×100%.

### 3. Hot Box Performance Test

At room temperature, the batteries obtained from each example and comparative example were charged at a constant current of 1 C to 4.55V, allowed to stand for 60 minutes, and then inspected for appearance and photographed. Then the temperature was raised at a rate of 3° C./min±2° C./min to 132° C.±2° C. and maintained for 60 minutes. The samples were observed, and a sample was recorded as passing the test if it showed no leakage, no smoke, no fire, and no explosion. 10 samples were tested for each example or comparative example, and the number of samples that passed the hot box performance test, n, was recorded as n/10.

The results of the specific tests were shown in the table below.

TABLE 2

| | | Thickness | |
|---|---|---|---|
| | | change | |
| | Cycling life | rate after | Hot box test |
| Group | at 25° C. /T | 500 T cycles | pass rate |
| Example 1 | 985 | 9.6% | 7/10 |
| Example 2 | 1003 | 9.4% | 7/10 |
| Example 3 | 1026 | 8.9% | 9/10 |
| Example 4 | 1015 | 8.7% | 8/10 |
| Example 5 | 998 | 9.2% | 8/10 |
| Example 6 | 1037 | 10.5% | 8/10 |
| Example 7 | 1125 | 9.6% | 10/10 |
| Example 8 | 1066 | 9.8% | 10/10 |
| Example 9 | 1049 | 9.9% | 10/10 |
| Example 10 | 1057 | 9.9% | 10/10 |
| Example 11 | 1034 | 10.1% | 10/10 |
| Example 12 | 1082 | 9.7% | 10/10 |
| Example 13 | 1068 | 9.9% | 10/10 |
| Example 14 | 985 | 11.5% | 8/10 |
| Example 15 | 1001 | 10.8% | 9/10 |
| Example 16 | 1054 | 10.0% | 10/10 |
| Example 17 | 1032 | 10.2% | 10/10 |
| Example 18 | 1011 | 10.8% | 10/10 |
| Example 19 | 999 | 10.9% | 9/10 |
| Example 20 | 979 | 11.1% | 10/10 |
| Example 21 | 1118 | 9.8% | 10/10 |
| Example 22 | 1013 | 10.9% | 9/10 |
| Example 23 | 1055 | 9.9% | 10/10 |
| Example 24 | 1032 | 10.3% | 9/10 |
| Example 25 | 975 | 11.4% | 9/10 |
| Example 26 | 1009 | 11.1% | 9/10 |
| Example 27 | 989 | 10.9% | 8/10 |
| Example 28 | 958 | 11.3% | 7/10 |
| Example 29 | 1066 | 10.0% | 10/10 |
| Example 30 | 1075 | 10.1% | 10/10 |
| Example 31 | 1043 | 10.5% | 9/10 |
| Example 32 | 1005 | 10.7% | 10/10 |
| Example 33 | 978 | 10.9% | 10/10 |
| Example 34 | 1057 | 8.8% | 10/10 |
| Example 35 | 1025 | 10.3% | 8/10 |
| Example 36 | 1015 | 10.1% | 10/10 |
| Example 37 | 1034 | 9.8% | 10/10 |
| Example 38 | 996 | 10.3% | 9/10 |
| Example 39 | 1085 | 9.8% | 8/10 |
| Comparative Example 1 | 785 | 15.6% | 5/10 |
| Comparative Example 2 | 852 | 14.8% | 6/10 |
| Comparative Example 3 | 824 | 15.2% | 6/10 |
| Comparative Example 4 | 875 | 14.4% | 6/10 |
| Comparative Example 5 | 901 | 13.8% | 6/10 |
| Comparative Example 6 | 818 | 14.8% | 5/10 |
| Comparative Example 7 | 881 | 14.0% | 6/10 |

As can be seen from the data in the table above, in the examples provided in the present application, by using specific amounts of a lithium cobalt oxide material and a lithium nickel cobalt manganese oxide ternary material in combination, and by adding a compound A, a compound B and a compound C into the electrolyte for combined use, and by adjusting and controlling the amount of each component within the range defined in the application, the cycling performance and safety performance can be improved while reducing costs and improving the energy density.

Obviously, the above examples are merely examples given for clarity of illustration and are not intended to limit the embodiments. For those of ordinary skill in the art, other different forms of changes or variations could have also been made on the basis of the above-mentioned illustrations. There is no need to exhaustively list all embodiments herein, although it cannot be achieved. The obvious changes or variations thus derived are still within the scope of protection of the invention.

1. A lithium-ion secondary battery, comprising a positive electrode, a negative electrode, and an electrolyte,
wherein the positive electrode comprises a positive electrode current collector and an active layer coated on at least one surface of the positive electrode current collector, and the active layer comprises a positive electrode active material, the positive electrode active material comprising a lithium cobalt oxide material and a lithium nickel cobalt manganese oxide ternary material, with the mass content percentage of the lithium nickel cobalt manganese oxide ternary material being d % based on the total mass of the positive electrode active material, where 1≤d≤50;
and wherein the electrolyte comprises a compound A, a compound B, and a compound C, wherein the compound B comprises a polyether nitrile compound, the compound C comprises 1,3,6-hexanetricarbonitrile; the compound A has a structure as represented by the following general formula: 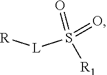
wherein L is O or a linking bond; R is selected from one of C₂-C₆alkyl which is unsubstituted or substituted with Ra, C₂-C₆alkenyl which is unsubstituted or substituted with Ra, C₂-C₆ alkynyl which is unsubstituted or substituted with Ra, C₂-C₆ nitrogen-containing heteroaryl which is unsubstituted or substituted with Ra, C₆-C₁₂ aryl which is unsubstituted or substituted with Ra, wherein each substituent Ra is independently selected from fluoro or C₁-C₆fluoroalkyl; and R₁ is selected from one of fluoro or C₁-C₆ fluoroalkyl;
based on the total mass of the electrolyte, the mass content percentage of the compound A is a %, where 0.1≤a≤15; the mass content percentage of the compound B is b %, where 0.1<b≤5; and the mass content percentage of the compound C is 0.1≤c≤5; and 0.3≤d/(b+c)<20 and 0.02≤a/(b+c)<2 are satisfied.

2. The lithium-ion secondary battery according to claim 1, wherein the compound A has any of the structures as represented by the following formulae:

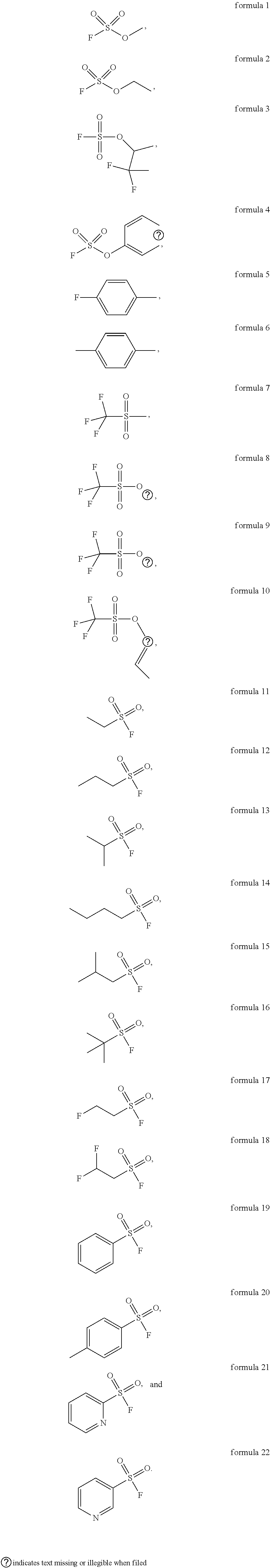

3. The lithium-ion secondary battery according to claim 1, wherein the compound B comprises at least one of 1,2,3,4,5-penta(2-cyanoethoxy)pentane, ethylene glycol di(2-cyanoethyl) ether, diethylene glycol di(2-cyanoethyl) ether, triethylene glycol di(2-cyanoethyl) ether, tetraethylene glycol di(2-cyanoethyl) ether, ethylene glycol di(4-cyanobutyl) ether, ethylene glycol bis(propionitrile) ether, and 1,2,3-tris(2-cyanoxy)propane.

4. The lithium-ion secondary battery according to claim 1, wherein the compound C further comprises at least one of benzonitrile, p-tolunitrile, 3,5-difluorobenzonitrile, adiponitrile, succinonitrile, 1,2,6-hexanetricarbonitrile, 3,5-bis(trifluoromethyl)benzonitrile, ethoxypentafluorocyclotriphosphazene, and hexafluorocyclotriphosphazene.

5. The lithium-ion secondary battery according to claim 1, wherein the electrolyte further comprises a lithium salt in a mass content percentage of 10-30% based on the total mass of the electrolyte.

6. The lithium-ion secondary battery according to claim 5, wherein
the lithium salt comprises lithium hexafluorophosphate and lithium bis(trifluoromethanesulfonyl)imide, with the mass content percentage of lithium hexafluorophosphate being e %, and the mass content percentage of lithium bis(trifluoromethanesulfonyl)imide being f %, based on the total mass of the electrolyte, and 8≤e≤20, 0.5≤f≤10, and 1≤e/f≤5 are satisfied.

7. The lithium-ion secondary battery according to claim 1, wherein the electrolyte further comprises ethylene carbonate in a mass content percentage of g % based on the total mass of the electrolyte, and 0.1<g≤20 and 0.1≤a/g≤0.8 are satisfied.

8. The lithium-ion secondary battery according to claim 1, wherein the electrolyte further comprises a sulfur-containing additive in a mass content percentage of h % based on the total mass of the electrolyte, and 0.1<h<6 and 0.3≤h/a≤3 are satisfied.

9. The lithium-ion secondary battery according to claim 8, wherein
the sulfur-containing additive has any of the structures as represented by the following formulae:

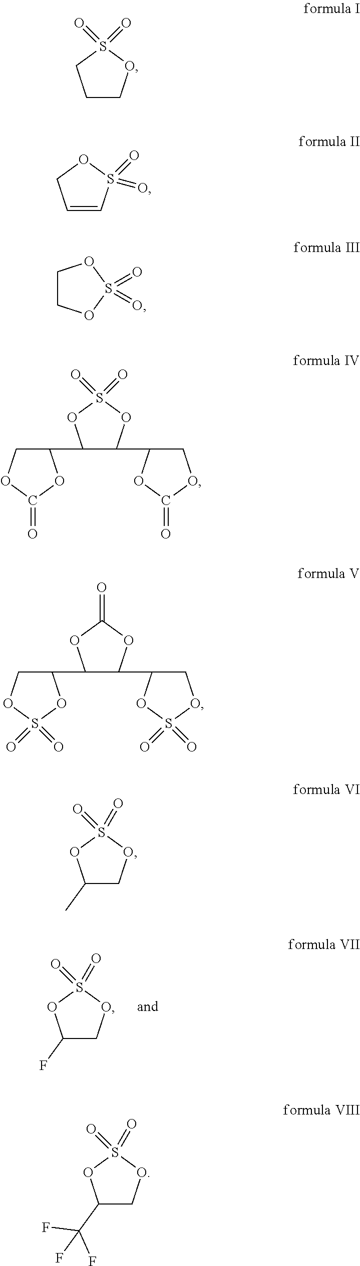

10. The lithium-ion secondary battery according to claim 1, wherein the positive electrode active material further comprises an aluminum element, in a mass content percentage of i % based on the total mass of the positive electrode active material, where 0.3≤i≤1.2.

11. The lithium-ion secondary battery according to claim 1, wherein the negative electrode comprises a negative electrode active material, which includes graphite and a silicon-carbon composite material, with the mass content percentage of the silicon element in the silicon-carbon composite material being j %, where 0.5≤j≤35.

12. The lithium-ion secondary battery according to claim 11, wherein 0.1≤j/a≤10 is satisfied.

13. A power consuming device, comprising a lithium-ion secondary battery, wherein the lithium-ion secondary battery comprises a positive electrode, a negative electrode, and an electrolyte,
wherein the positive electrode comprises a positive electrode current collector and an active layer coated on at least one surface of the positive electrode current collector, and the active layer comprises a positive electrode active material, the positive electrode active material comprising a lithium cobalt oxide material and a lithium nickel cobalt manganese oxide ternary material, with the mass content percentage of the lithium nickel cobalt manganese oxide ternary material being d % based on the total mass of the positive electrode active material, where 1≤d≤50;
and wherein the electrolyte comprises a compound A, a compound B, and a compound C, wherein the compound B comprises a polyether nitrile compound, the compound C comprises 1,3,6-hexanetricarbonitrile; the compound A has a structure as represented by the following general formula: 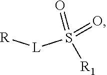
wherein L is O or a linking bond; R is selected from one of C₂-C₆alkyl which is unsubstituted or substituted with Ra, C₂-C₆alkenyl which is unsubstituted or substituted with Ra, C₂-C₆ alkynyl which is unsubstituted or substituted with Ra, C₂-C₆ nitrogen-containing heteroaryl which is unsubstituted or substituted with Ra, C₆-C₁₂ aryl which is unsubstituted or substituted with Ra, wherein each substituent Ra is independently selected from fluoro or C₁-C₆fluoroalkyl; and R₁ is selected from one of fluoro or C₁-C₆ fluoroalkyl;
based on the total mass of the electrolyte, the mass content percentage of the compound A is a %, where 0.1≤a≤15; the mass content percentage of the compound B is b %, where 0.1≤b≤5; and the mass content percentage of the compound C is 0.1≤c≤5; and 0.3≤d/(b+c)≤20 and 0.02≤a/(b+c)≤2 are satisfied.
